(19) United States
(12) Patent Application Publication
(10) Pub. No.: US 2008/0154724 A1
(43) Pub. Date: Jun. 26, 2008

(54) DEVICE, SYSTEM, AND METHOD OF RECOMMENDATION-BASED REWARDING

(76) Inventors: Yuval Machlin, Kadima (IL); Alon Strasman, Raanana (IL); Amir Milo, Tel Aviv (IL); Uri Ginsburg, Ramat-Gan (IL)

Correspondence Address: EMPK & Shiloh, LLP, 116 JOHN ST,, SUITE 1201, NEW YORK, NY, 10038, US

(21) Appl. No.: 11/958,420

(22) Filed: Dec. 18, 2007

Related U.S. Application Data
(60) Provisional application No. 60/876,152, filed on Dec. 21, 2006.

(51) Int. Cl. G06Q 30/00; H04Q 7/20

(52) U.S. Cl. 705/14; 455/466

(57) ABSTRACT

Some embodiments include, for example, devices, systems, and methods of recommendation-based transaction rewarding. A method may include, for example, receiving from a cellular phone associated with a recommender of an item a request message to recommend the item to at least one addressee, wherein the request message includes item identification information identifying the item, a number of the cellular phone, and addressee identification information identifying the addressee; based on the recommendation request message, sending a recommendation to the addressee, wherein the recommendation includes item details sufficient to identify the item to the addressee, and recommender details sufficient to identify the recommender to the addressee, wherein the recommender details are based on the number of the cellular phone; receiving transaction information indicating that the addressee has performed a transaction with relation to the item; and updating a reward account of the recommender based on the transaction information.

### CROSS-REFERENCE

This application claims priority from and the benefit of U.S. Provisional Patent application 60/876,152, entitled “System and method for marketing and promoting any kind of products and/or services by friend tells a friend and commissioning the teller and measure campaign effectiveness”, filed Dec. 21, 2006, the entire disclosure of which is incorporated herein by reference.

### FIELD

Some embodiments are related to the field of recommendation-based rewarding of transactions.

### BACKGROUND

A buyer may buy a product or service, e.g., at a physical or virtual store, based on an advertisement and/or promotion.

There are many ways to promote products or services, for example, a friend's recommendation, newspaper advertisements, television promotions, fliers, radio advertisements, display window presentations, internet advertisements, cellular advertisements, door to door agents and so on.

Accordingly, it may be very expensive and/or complicated for a merchant to reach a large number of potential clients, and/or to measure the effectiveness of each and every promotion campaign.

### SUMMARY

Some embodiments include, for example, devices, systems, and methods of recommendation-based transaction rewarding.

Some demonstrative embodiments include a method of recommendation-based transaction rewarding. The method may include receiving from a cellular phone associated with a recommender of an item a request message to recommend the item to at least one addressee, wherein the request message includes item identification information identifying the item, a number of the cellular phone, and addressee identification information identifying the addressee; based on the recommendation request message, sending a recommendation to the addressee, wherein the recommendation includes item details sufficient to identify the item to the addressee, and recommender details sufficient to identify the recommender to the addressee, wherein the recommender details are based on the number of the cellular phone; receiving transaction information indicating that the addressee has performed a transaction with relation to the item; and updating a reward account of the recommender based on the transaction information.

In some demonstrative embodiments, the addressee identification information includes a cellular phone number associated with the addressee. Sending the recommendation may include sending a message to the cellular phone number of the addressee.

In some demonstrative embodiments, the method may include sending updated account information related to the updated reward account to the recommender.

In some demonstrative embodiments, the method may include updating an addressee reward account of the addressee based on the transaction information; and sending to the addressee a message including information related the updated reward account of the addressee.

In some demonstrative embodiments, receiving the transaction information may include receiving coupon information sufficient to identify a coupon provided to the addressee.

In some demonstrative embodiments, the coupon may include a coupon provided to the addressee upon performing the transaction. Receiving the coupon information may include receiving the coupon information from the addressee.

In some demonstrative embodiments, the method may include providing the coupon to the addressee; and receiving the coupon information if the addressee performs the transaction.

In some demonstrative embodiments, the item details include at least one of a name of the item, a description of the item, a location corresponding to the item, details of a provider of the item, and a price of the item; and wherein the recommender details include at least one of a name of the recommender, a nickname of the recommender, an electronic-mail address of the recommender, an instant-messaging identity of the recommender, and a phone number of the recommender.

In some demonstrative embodiments, the item identification information may include an offer code sufficient to identify a predefined offer of the item.

In some demonstrative embodiments, the request message may include a short-message-service message.

In some demonstrative embodiments, the addressee is the recommender.

In some demonstrative embodiments, a method of recommendation-based transaction rewarding may include receiving a recommendation request message to recommend an item to at least one addressee, wherein the recommendation request message includes item identification information identifying the item, message generator information identifying a generator of the request message, an authentication of the generator information, and addressee identification information identifying the addressee; based on the recommendation request message, sending a recommendation to the addressee, wherein the recommendation includes item details sufficient to identify the item to the addressee, and recommender details sufficient to identify a recommender of the item to the addressee, wherein the recommender details are based on the message generator information; receiving transaction information indicating that the addressee has performed a transaction with relation to the item; and updating a reward account of the recommender based on the transaction information.

In some demonstrative embodiments, the transaction information indicates the addressee has performed the transaction with relation to the item based on the recommendation.

In some demonstrative embodiments, the transaction information includes information relating to a plurality of transactions. The method may include detecting whether the addressee has performed the transaction based on the recommendation.

In some demonstrative embodiments, the method may include sending to the recommender updated account information related to the updated reward account.

In some demonstrative embodiments, the method may include updating an addressee reward account of the addressee based on the transaction information; and sending to the addressee updated account information related to the updated reward account of the addressee.

In some demonstrative embodiments, receiving the transaction information may include receiving coupon information sufficient to identify a coupon provided to the addressee.

Some demonstrative embodiments may include a recommendation-based transaction rewarding server. The server may be capable of receiving from a cellular phone associated with a recommender of an item a request message to recommend the item to at least one addressee, wherein the request message includes item identification information identifying the item, a number of the cellular phone, and addressee identification information identifying the addressee; based on the recommendation request message, sending a recommendation to the addressee, wherein the recommendation includes item details sufficient to identify the item to the addressee, and recommender details sufficient to identify the recommender to the addressee, wherein the recommender details are based on the number of the cellular phone; receiving transaction information indicating that the addressee has performed a transaction with relation to the item; and updating a reward account of the recommender based on the transaction information.

In some demonstrative embodiments, the addressee identification information includes a cellular phone number associated with the addressee, and wherein sending the recommendation may include sending a message to the cellular phone number of the addressee.

In some demonstrative embodiments, the server is capable of sending to the recommender updated account information related to the updated reward account.

In some demonstrative embodiments, the server is capable of updating an addressee reward account of the addressee based on the transaction information; and sending to the addressee a message including information related the updated reward account of the addressee.

In some demonstrative embodiments, the transaction information may include coupon information sufficient to identify a coupon provided to the addressee.

In some demonstrative embodiments, the request message may include a short-message-service message.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic flow-chart illustration of a method of recommendation-based rewarding in accordance with some demonstrative embodiments;

FIG. 2 is a schematic block diagram illustration of a system able to handle recommendation-based rewarding in accordance with some demonstrative embodiments;

FIG. 3 is a schematic illustration of a recommendation scheme in accordance with one demonstrative embodiment;

FIG. 4 is a schematic illustration of a recommendation scheme in accordance with another demonstrative embodiment;

FIG. 5 is a schematic illustration of a recommendation-based rewarding scheme in accordance with one demonstrative embodiment;

FIG. 6 is a schematic illustration of a recommendation-based rewarding scheme in accordance with another demonstrative embodiment;

FIG. 7 is a schematic illustration of a recommendation-based rewarding scheme in accordance with another demonstrative embodiment; and

FIG. 8 is a schematic illustration of a recommendation-based rewarding scheme in accordance with yet another demonstrative embodiment.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or, “two or more”. For example, “a plurality of items” includes two or more items.

Some embodiments may include apparatuses for performing the operations herein. These apparatuses may be specially constructed for the desired purposes, or they may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, a Dynamic RAM (DRAM), a Synchronous DRAM (SD-RAM), a Flash memory, a volatile memory, a non-volatile memory, a cache memory, a buffer, a short term memory unit, a long term memory unit, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, some embodiments are not described with reference to any particular programming language. It will be appreciated that a variety of programming languages may be used to implement the teachings described herein. Although embodiments of the invention are not limited in this respect, some demonstrative embodiments may be implemented using any suitable embedded system.

Some embodiments may utilize wired communication and/or wireless communication. Although portions of the discussion herein relate, for demonstrative purposes, to wired links and/or wired communications, embodiments of the invention are not limited in this regard, and may include one or more wired or wireless links, may utilize one or more components of wireless communication, may utilize one or more methods or protocols of wireless communication, or the like.

Some embodiments may be used in conjunction with various devices and systems, for example, a Personal Computer (PC), a desktop computer, a mobile computer, a laptop computer; a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth, Global Positioning System (GPS), Wi-Fi, Wi-Max, ZigBee, Global System for Mobile communication (GSM), 2G, 2.5G, 3G, 3.5G, or the like. Some embodiments may be used in various other devices, systems and/or networks.

Part of the discussion herein may relate, for demonstrative purposes, to rewarding a recommender of an item based on one or more transactions performed with relation to the item.

The term “item” as used herein may refer to any suitable product or service. The product may include, for example, any suitable commodity, merchandise, and/or goods. The service may include, for example, any economic activity, operation and/or action relating to non-material goods, e.g., one or more benefits non-material delivered by a service provider. The service may also include the allowing or providing the possibility and/or right to enter and/or visit a public and/or private place, site, location, and the like.

The term “transaction” as used herein may refer to a selling action, operation or activity; a buying action, operation or activity; an exchange; a trade; a commercial action, operation or activity; an activity, for example, a physical activity, e.g., arriving at, visiting, and/or entering a place, site, location, and the like; a deal; a purchase, a donation, a gift, a contribution, and/or a sale performed with relation to an item. The transaction may be performed online and/or offline, e.g., using an Interactive Voice Response (IVR) system, via a call to a representative of the item, a face-to-face operation, e.g., in store, using an e-commerce system, using a coupon, and the like.

The term “reward” as used herein may refer to any suitable compensation, commission, payment, benefit, bonus, prize, credit, and/or gift. In one example, the reward may include a cash payment. In another example, the reward may include a credit of an account, e.g., a bank account, a credit card account, a cellular phone account, and the like. In another example, the reward may include “credit points” to be redeemed as part of one or more future transactions.

Some demonstrative embodiments may be implemented to enable a user, e.g., a person or business, to actively promote an item by recommending the item to one or more other users, e.g., people and/or businesses. In some demonstrative embodiments, the user and/or the other users may be rewarded for one or more transactions performed by the other users based on the recommendation, e.g., as described below. In some embodiments, the user may be implemented, for example, as a user account and/or a group account.

Some demonstrative embodiments may implement a recommendation request message including authenticated identification information to authentically identify the recommender and/or a message generator used by the recommender to generate the request message, e.g., as described in detail below. Such implementation may ensure, for example, that the request message does not include an unsolicited and/or unwanted message, e.g., a spam or junk message generated, for example, by a spam generator, e.g., automatically.

In some non-limiting demonstrative embodiments, the recommendation request may include a cellular message received via a cellular network, e.g., an SMS message, and MMS message, and the like, e.g., as described in detail below. The cellular message may include, for example, an authenticated cellular phone number identifying a cellular phone account from which the message has originated.

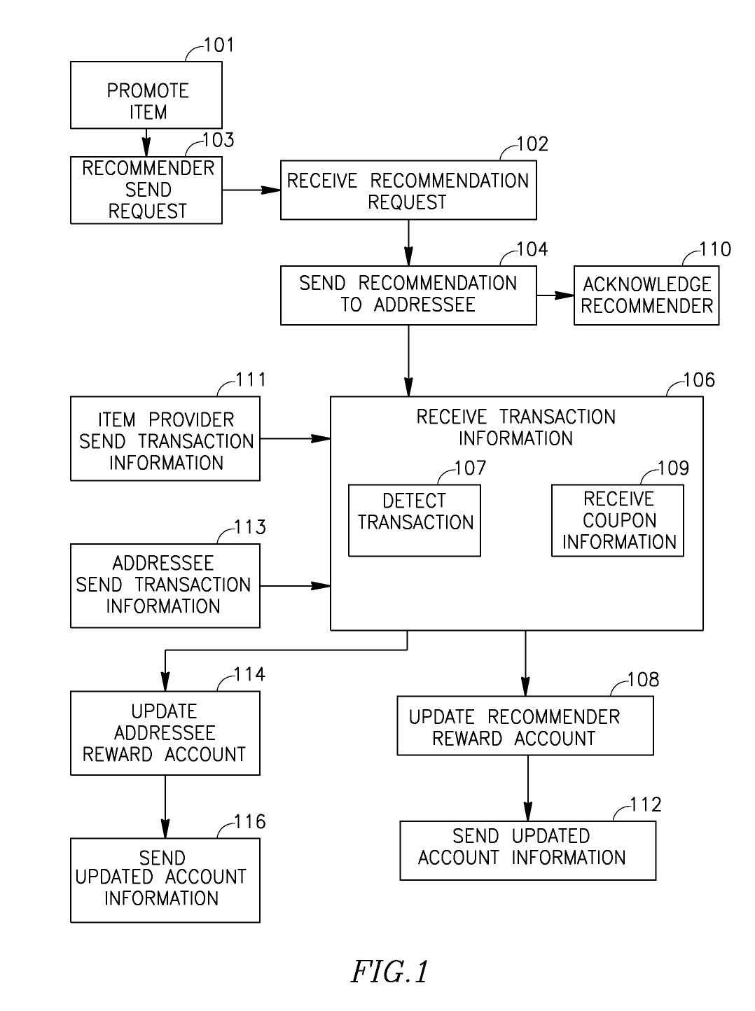

Reference is now made to FIG. 1, which schematically illustrates a method of recommendation-based rewarding in accordance with some demonstrative embodiments.

In some demonstrative embodiments, one or more operation of the method of FIG. 1 may be implemented to reward at least one recommender and/or at least one addressee for at least one transaction performed by the addressee with relation to at least one item based on a recommendation from the recommender, e.g., as described in detail below.

As indicated at block 102, the method may include receiving a recommendation request message to recommend an item to at least one addressee. The recommendation request message may have any suitable type and/or format, and may be received via any suitable communication medium. For example, the recommendation request may include a cellular message received via a cellular communication network, e.g., as described below.

In one example, the recommendation request message may include a cellular message, e.g., a Short Message Service (SMS) message, a Multimedia Message Service (MMS) message, and the like. In another example, the recommendation request message may include an electronic mail (E-mail) message, e.g., in accordance with the Simple Mail Transfer Protocol (SMTP), the Hyper Text Transfer Protocol (HTTP), and the like. In another example, the recommendation request message may include an Instant Message (IM), an ICQ message, an America-Online Instant Messenger (AIM) message, a Windows Live Messenger (WLM) message, a QQ message, a Skype message, an Extensible Messaging and Presence Protocol (XMPP) message, a Mobile Instant Messaging (MIM) message, an Enterprise Instant Messaging (EIM) message, an IVR message, and the like.

In some demonstrative embodiments, the recommendation request message may include item identification information identifying the item, and addressee identification information identifying the addressee, e.g., as described below.

In some demonstrative embodiments, the recommendation request message may also include message generator information identifying a generator of the request message, and an authentication of the generator information.

In some demonstrative embodiments, the message generator information and addressee identification information may include any suitable information in any suitable format sufficient to identify the recommender; e.g., to the recommendation-based reward server as described below. For example, the message generator information may include a phone number, an IM account number, an E-mail address, and/or a nickname of the recommender; and/or the addressee identification information may include a phone number, an IM account number, an E-mail address, and/or a nickname of the addressee.

In one example, the request message includes a cellular message generated by a cellular phone associated with the recommender. Accordingly, the message generator information may include the cellular phone number, and the authentication may include one or more authentication symbols, e.g., according to any suitable authentication certification protocol, indicating that the cellular phone number is authentic.

In some demonstrative embodiments, the cellular message may enable a recommendation-based reward server, e.g., as described below, to authentically identify the recommender, based on the authenticated cellular phone number, e.g., without requiring the recommender to perform any authentication, identification, registration and/or log-on operations.

In some demonstrative embodiments, the authenticated identification of the recommender based on the authenticated cellular phone number may ensure that the recommendation request message has been generated, e.g., automatically, for example, by a spam generator.

In some demonstrative embodiments, the addressee may include or may be a person, a business an organization, a company, and/or any other entity capable of performing a transaction with relation to the item. The recommender may include or may be a person, a business an organization, a company, and/or any other entity acquainted, associated, familiar and/or having any other connection with the addressee. In one example, the recommender and addressee may include different entities, e.g., friends, colleagues, companions, acquaintances, and the like. In another example, the recommender and addressee may be the same entity. For example, a person may send a recommendation request relating to an item and identifying herself as the addressee, e.g., in order to remind her to perform a transaction with relation to the item, and/or in order to be awarded for performing the transaction. A provider of the item may benefit from such self-recommendation, since for example, the reminder and/or reward may increase the probability that the recommender/addressee will perform the transaction.

In some demonstrative embodiments, the item identification information may include any suitable information in any suitable format sufficient to identify the item, e.g., to a recommendation-based reward server as described below. In some demonstrative embodiments, the identification information may include an offer code sufficient to identify an offer of the item by a provider of the item.

As indicated at block 101, in some demonstrative embodiments, the method may include promoting the item. For example, the item may be advertised and/or promoted together with and/or in connection with the offer code. The offer code may include any suitable string of characters, e.g., numbers, signs and/or letters, to identify, e.g., uniquely, the offer of the item to the recommendation-based reward server. The offer code may be provided to the recommender using, for example, passive and/or active advertising methods. The offer code may be passively advertised, for example, using any suitable advertisement media, e.g., printed media; internet-media; an on-line advertisement; an off-line advertisement; information received via a web site, ICQ, or other IM service, a chat, an E-mail, a Web-log (blog), an SMS, an MMS, a video file; broadcast-media; a newspaper advertisement; a sticker; a sign; a placard; a poster; a flier; a notice; information printed on or embedded in the item; a television advertisement; an E-mail advertisement; an SMS-advertisement; an internet advertisement; an internet banner; a radio advertisement, and the like. Additionally or alternatively, the offer code may be actively advertised, for example, using a salesperson, a phone call, a “more info” campaign asking potential customers to call-in for additional information, and the like. As indicated at block 103, in some demonstrative embodiments the recommender may send the recommendation request message, e.g., based on the promotion to the item as described below.

In some demonstrative embodiments, the recommendation request message may optionally include any suitable message (“personal message”) from the recommender to the addressee. The personal message may include any suitable communication, note, and/or information, e.g., including a file, e.g., an image file, a video file, and/or an audio file; and/or a link, a hyperlink, and/or any suitable referral to any suitable audio, video and/or image message, e.g., in the form of a voice mail.

In one example (“Example 1”), the recommender may be a person named Joe Cohen and having a cell-pone number 012-3456789, the item may be an LCD display having a part number “AB-123”, offered on sale for 99.99$ by a store named “LCD-store” under an offer code “offer-01”. Joe would like to recommend the LCD display to a friend named Jacob, and having a cell-pone number 023-4567890. According to this example, Joe may use his cell phone to send an SMS message, for example, to a phone number, e.g., “*123”, of the recommendation-based reward server as described below. The message may include for example the following message format, or any other similar format: “offer-01, 023-4567890, hi Jacob I saw this LCD display which I know you would like to buy, it's at a great price!!”. The SMS message may include details of Joe's cell-phone number and an authentication of Joe's cell-phone number, e.g., automatically. According to this example, receiving the recommendation request message may include receiving, e.g., at the recommendation-based reward server as described below, the SMS sent by Joe and/or a message corresponding to or including the SMS message, wherein the message generator information may include Joe's cell-phone number, the item identification information may include the offer code “offer-01”, the addressee identification information may include Jacob's cell-phone number, and the personal message may include the message “hi Jacob I saw this LCD display which I know you would like to buy, it's at a great price!!”.

As indicated at block 104 the method may also include sending a recommendation to the addressee based on the recommendation request message. The recommendation may have any suitable type and/or format, e.g., similar to or different than the format and/or type of the recommendation request message. For example, the recommendation may be sent via the Internet and/or a mobile communication system, e.g., as described below. For example, the recommendation may include a recommendation message, e.g., in the form of an E-mail message, an IM, an ICQ message, an AIM message, a WLM message, a QQ message, a Skype message, an XMPP message, a MIM message, an EIM message, an IVR message, and the like.

In some demonstrative embodiments, the recommendation may include item details sufficient to identify the item to the addressee, and recommender details sufficient to identify the recommender to the addressee. The recommender details may be based, for example, on the message generator information of the recommendation request message, e.g., as described below. In one example, the recommender details may include the message generator information. For example, the recommender details may include the cellular phone number of the recommender. In another example, the recommender details may include any other information, which may be determined based on the message generator information, e.g., a name and/or address associated with the cellular phone number of the recommender. The recommendation may optionally include the personal message from the recommender.

In some demonstrative embodiments, the item details may include at least one of a name of the item, a description of the item, a location corresponding to the item, details of a provider of the item, and a price of the item. For example, the item details may include a name of the item, e.g., “chair”; a model of the item, e.g., “kx35647”; a name of a store offering the item, e.g., “the chair”; an address of the store; and/or a price of the chair, e.g., “now on special offer for 10.99$”.

In some demonstrative embodiments, the recommender details may include at least one of a name of the recommender, an IM name of the recommender, a nickname of the recommender, an E-mail address of the recommender, and a phone number of the recommender.

According to Example 1 described above, the recommendation may include, for example, an SMS message sent to Jacob. The SMS message may include item details sufficient to identify the LCD display to Jacob, recommender details sufficient to identify Joe to Jacob, and the personal message from Joe. The SMS message may include for example the following message format, or any other similar format: “Joe Cohen has recommend to you the LCD display AB-123 offered on sale at the LCD-store for 99.99$, Joe says: hi Jacob I saw this LCD display which I know you would like to buy, it's at a great price!!”.

In some demonstrative embodiments, the recommendation may optionally include any other suitable additional information. In one example, the recommendation may include location-based information corresponding to a location of the addressee. For example, the location of the addressee may be determined based on suitable location information received, manually or automatically, from the addressee and/or a service provider, e.g., a mobile phone company. The location-based information may include, for example, information of a provider proximate to the addressee. In another example, the recommendation may include suitable direction and/or navigation information, e.g., Global-Positioning-System (GPS) navigation instructions, to direct the addressee to the provider. In some embodiments, the recommendation may also include any suitable communication, note, and/or information, e.g., including a file, e.g., an image file, a video file, and/or an audio file; and/or a link, a hyperlink, and/or any suitable referral to any suitable audio, video and/or image message, e.g., in the form of a voice mail. In some embodiments, the recommendation may also include forwarding-instructions to instruct the addressee how to forward the recommendation to another user.

As indicated at block 110, in some demonstrative embodiments the method may include sending an acknowledgment to the recommender to acknowledge the sending of the recommendation, e.g., as described below. In some non-limiting examples the method may include sending an error message to the recommender, for example, if the sending of the recommendation had failed; if an error was detected in the item identification information and/or the addressee identification information; and/or if a campaign corresponding to the recommendation request has ended, e.g., as described below.

As indicated at block 106, the method may also include receiving transaction information indicating that the addressee has performed a transaction with relation to the item, e.g., as described below. The transaction information may be received in any suitable manner. For example, the transaction information may be received offline and/or online, e.g., via the Internet and/or any other suitable communication system, e.g., as described below.

As indicated at block 111, in some demonstrative embodiments the method may include receiving the transaction information from a provider of the item, e.g., as described below.

As indicated at block 113, in some demonstrative embodiments the method may include receiving the transaction information from the addressee, e.g., as described below. In other embodiments, the transaction information may be received from any other suitable entity, e.g., as described below.

The transaction information may be received in any suitable format, e.g., as described below.

In some demonstrative embodiments, the transaction information indicates that the addressee has performed the transaction with relation to the item based on the recommendation. For example, the transaction information may be received as part of a message, a coupon, a transmission, and/or communication including information relating individually to the transaction, e.g., as described below.

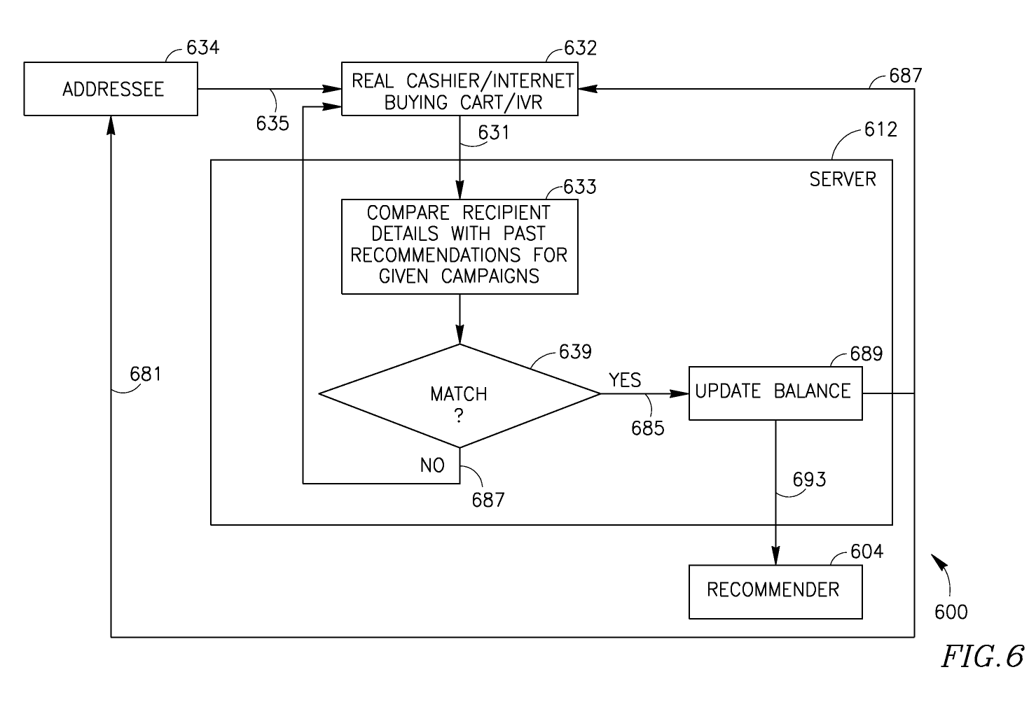

In some demonstrative embodiments, the transaction information may include information relating to a plurality of transactions. For example, the transaction information may be received part of a report, a list, and/or file including information relating to a plurality of transactions. As indicated at block 107, the method may also include detecting whether the addressee has performed the transaction based on the recommendation, e.g., as described below with reference to FIG. 6.

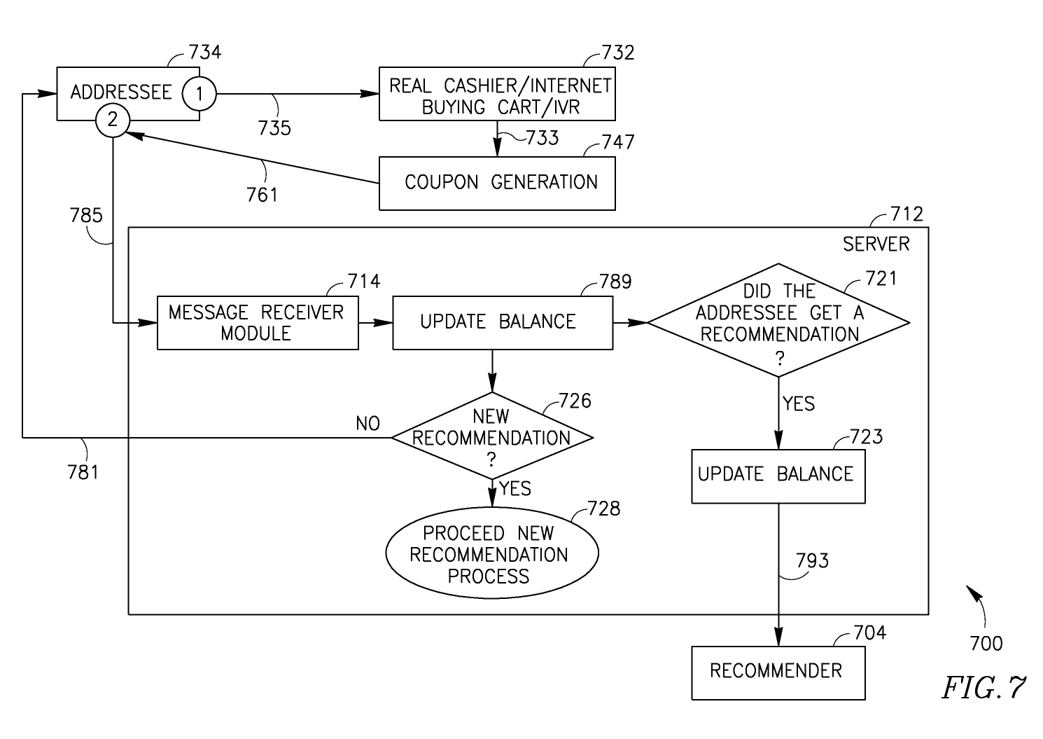

As indicated at block 109, in some demonstrative embodiments receiving the transaction information may include receiving coupon information sufficient to identify a coupon provided to the addressee, e.g., as described below with reference to FIGS. 7 and/or 8.

In one example, the coupon may include a coupon provided to the addressee upon performing the transaction; and receiving the coupon information may include receiving the coupon information from the addressee, e.g., as described below with reference to FIG. 7.

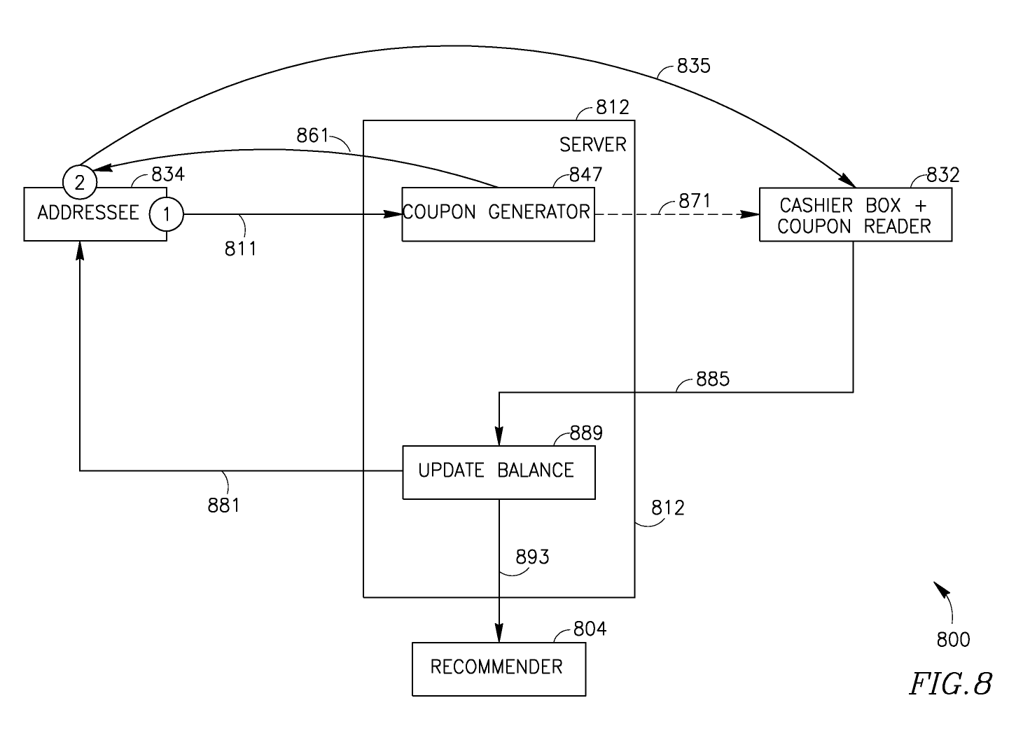

In another example, the method may include providing the coupon to the addressee, for example, together with the recommendation; and receiving the coupon information from the provider of the item, for example, upon the addressee performing the transaction, e.g., as described below with reference to FIG. 8.

As indicated at block 108, in some demonstrative embodiments the method may include updating a reward account of the recommender based on the transaction information, e.g., as described below.

As indicated at block 112, in some demonstrative embodiments the method may include sending to the recommender updated account information related to the updated reward account, e.g., as described below. In one example, the updated account information may include details of an updated reward balance in the reward account. In another example, the updated account information may include information indicating to the recommender that the reward account has been updated and, optionally, instructions allowing to the recommender to access the reward account.

As indicated at block 114, in some demonstrative embodiments the method may include updating an addressee reward account of the addressee based on the transaction information, e.g., as described below.

As indicated at block 116, in some demonstrative embodiments the method may include sending to the addressee a message including information related to the updated reward account of said addressee, e.g., as described below. In one example, the message may include details of an updated reward balance in the reward account. In another example, the updated account information may include information indicating to the addressee that the reward account has been updated and, optionally, instructions allowing to the addressee to access the reward account. In some embodiments, the method may also include sending any other information to the addressee, e.g., forwarding-instructions to instruct the addressee how to forward the recommendation to another user.

Other suitable operations or sets of operations may be used in accordance with some embodiments.

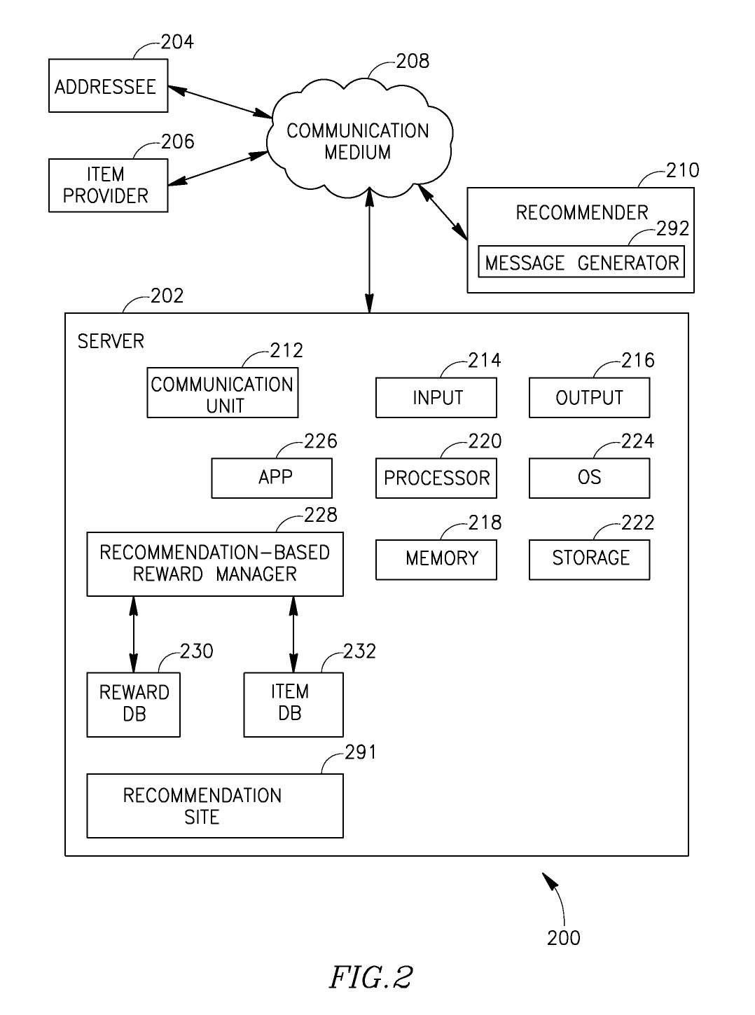

Reference is now made to FIG. 2, which schematically illustrates a system 200 able to handle recommendation-based rewarding in accordance with some demonstrative embodiments. Although embodiments of the invention are not limited in this respect, in some demonstrative embodiments system 200 may perform one or more operations of the method of FIG. 1, e.g., as described below.

In some demonstrative embodiments, system 200 may include a recommendation-based rewarding server 202 capable of rewarding at least one recommender 210 and/or at least one addressee 204 for at least one transaction performed, based on a recommendation from recommender 210, with relation to at least one item provided by at least one item provider 206 e.g., as described in detail below. In some embodiments recommendation-based rewarding server 202 may be implemented as part of any suitable module, server and/or system capable of performing any other suitable operations and/or provide any suitable services. For example, recommendation-based rewarding server 202 may be implemented as a white label application or service. In other embodiments, recommendation-based rewarding server 202 may be implemented may be implemented as a separate and/or dedicated application and/or service.

In some demonstrative embodiments, server 202 may include a recommendation-based reward manager 228 capable of receiving a recommendation request message to recommend an item recommended by recommender 210, to at least one addressee 204; based on the recommendation request, sending a recommendation to addressee 204; receiving transaction information indicating that addressee 204 has performed a transaction with relation to the item; and updating a reward account of recommender 210 based on the transaction information, e.g., as described below.

In some demonstrative embodiments, server 202 may include, for example, a processor 220, an input unit 214, an output unit 216, a memory unit 218, a storage unit 222, and/or a communication unit 212. Server 202 may optionally include other suitable hardware components and/or software components.

Processor 220 may include, for example, a Central Processing Unit (CPU), a Digital Signal Processor (DSP), one or more processor cores, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 220 may execute instructions, for example, of an Operating System (OS) 224 of server 202 and/or of one or more software applications 226.

Input unit 214 may include, for example, a keyboard, a keypad, a mouse, a touch-pad, a track-ball, a track-wheel, a thumb-wheel, a scroll-wheel, a stylus, one or more buttons or sliders, a microphone, or other suitable pointing device or input device. Output unit 216 may include, for example, a monitor, a screen, a Cathode Ray Tube (CRT) display unit, a Liquid Crystal Display (LCD) display unit, a plasma display unit, a projector, a projection device, a television, one or more audio speakers, or other suitable output devices.

Memory unit 218 may include, for example, a RAM, a ROM, a DRAM, a SD-RAM, a flash memory, a volatile memory, a non-volatile memory, a cache memory, a buffer, a short term memory unit, a long term memory unit, or other suitable memory units or storage units. Storage unit 122 may include, for example, a hard disk drive, a floppy disk drive, a Compact Disk (CD) drive, a CD-ROM drive, a Digital Versatile Disk (DVD) drive, a magnetic storage device, an optical storage device, a storage device utilizing removable storage mediums or storage articles, or other suitable removable or non-removable storage units.

Communication unit 212 may include any suitable communication unit capable of communicating over a communication medium 208. Communication medium 208 may include at least one of the Internet, a telephone network, and a mobile and/or cellular communication network, e.g., a GSM, 2G, 2.5G, 3G, and/or 3.5G, and/or any other suitable mobile and/or cellular communication network. Communication unit 212 may be capable of communicating over communication medium 208 at least one of a mobile communication message, e.g., a SMS message, a MMS message, and the like; an E-mail message, e.g., in accordance with the SMTP, the HTTP; an IM message, an ICQ message, an AIM message, a WLM message, a QQ message, a Skype message, an XMPP message, a MIM message, an EIM message, an IVR message, and the like.

Communication unit 212 may include, for example, a wired or wireless Network Interface Card (NIC), a wired or wireless modem, a wired or wireless router or switch or hub, a wired or wireless receiver and/or transmitter, a wired or wireless transmitter-receiver and/or transceiver, a Radio Frequency (RF) communication unit or transceiver, or other units able to transmit and/or receive signals, blocks, frames, transmission streams, packets, messages and/or data over communication medium 208. Optionally, communication unit 212 may include, or may be associated with, one or more antennas, for example, a dipole antenna, a monopole antenna, an omni-directional antenna, an end fed antenna, a circularly polarized antenna, a micro-strip antenna, a diversity antenna, or the like.

In some demonstrative embodiments, server 202 may include an item database (DB) 232, which may include information relating to a plurality of items fox, which recommendation-based rewarding is to be performed. In one non-limiting example, item DR 232 may include a table having a plurality of table entries corresponding to the plurality of items, respectively. A table entry corresponding to an item may include, for example, the item's details sufficient to identify the item to one or more potential addressees, e.g., as described above; and the item identification information, e.g., the offer code, corresponding to the item, e.g., as described above. In other embodiments, item DB 232 may store the item identification information an/or item details relating to the plurality of items in any other suitable format.

In some demonstrative embodiments, server 202 may include a reward DB 230, which may include a plurality of reward accounts related to a plurality of users, e.g., including recommender 210 and/or addressee 204. Reward DB 230 may also include the identification details of the plurality of users, e.g., the message generator information and/or other details, of recommender 210 and/or addressee 204 as described above. In one non-limiting example, reward DB 230 may include a table having a plurality of table entries corresponding to the plurality of users, respectively. A table entry corresponding to a user may include, for example, the identification information identifying the user; e.g., as described above; and reward information corresponding the user. In one example, the reward account of a user may include, for example, an amount of cash to be paid to the user; an amount of money and/or credits to be credited to a bank account, a credit card account, and/or cellular phone account of the user; and/or an amount of “credit points” to be redeemed as part of one or more future transactions by the user. In one example, reward DB 230 may store the recommender details of recommender 210, for example, at least one of a name of recommender 210, an IM name of recommender 210, a nickname of recommender 210, an E-mail address of recommender 210, and a phone number of recommender 210, e.g., as described above. In other embodiments, reward DB 232 may store the identification information an/or reward relating to the plurality of users in any other suitable format.

In some demonstrative embodiments, databases 230 and/or 232 may be maintained internally be server 202, e.g., as part of storage 222; and/or externally to server 202, e.g., as part of one or more external, e.g., local or remote, databases.

In some embodiments, the components of server 202 may be enclosed in a common housing, packaging, or the like, and may be interconnected or operably associated using one or more wired or wireless links. In other embodiments, components of server 202 may be distributed among multiple or separate devices or locations, may be implemented using a client/server configuration, may communicate using remote access methods, or the like.

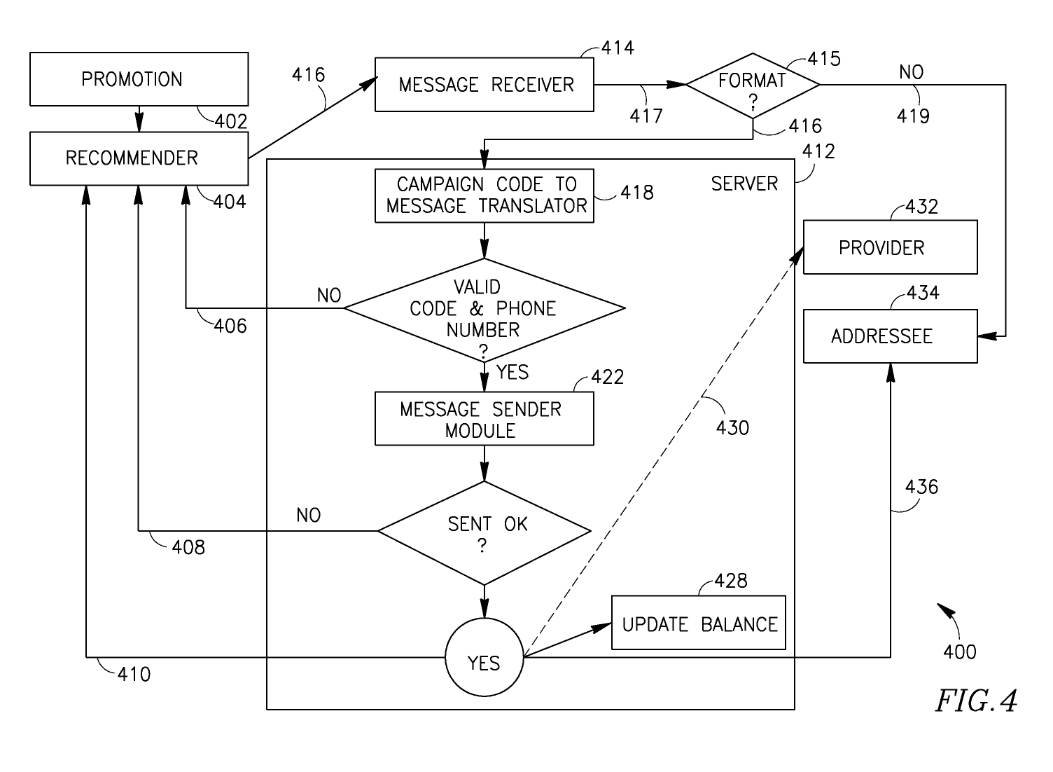

In some demonstrative embodiments, one or more elements of server 202 may be implemented as part of a network manager and/or network provider of communication medium 208, e.g., as described below with reference to FIG. 4.

In some demonstrative embodiments, item provider 206 may include, for example, a retail store, an online store, a service provider, an online service provider, a virtual provider, an internet provider, a cellular provider, and the like.

In some demonstrative embodiments, recommender 210 may implement any suitable message generator 292 to generate the recommendation request message. For example, message generator 292 may include a cellular phone to generate the recommendation request message in the form of a cellular message. In other examples message generator 292 may include a computing device, a computer, a PC, a mobile computer, a portable computer, a laptop computer; a notebook computer, a tablet computer, a handheld computer, a handheld device, a PDA device, a handheld PDA device, an on-board device, an off-board device, a hybrid device, a vehicular device, a non-vehicular device, a mobile or portable device, a non-mobile or non-portable device, a wireless communication station, a wireless communication device, a wireless telephone, a PCS device, a PDA device which incorporates a wireless communication device, a wired or wireless handheld device (e.g., BlackBerry, Palm Treo), a WAP device, or the like. In some demonstrative embodiments, message generator 292 may include a user-interface and/or an application capable of generating one or more recommendations to one or more addressees based, for example, on information of one or more of an address book, a contact list, a distribution list, and the like, which may be stored and/or accessed by message generator 292. For example, the user-interface and/or an application may enable recommender 210 to select one or more addressees from the address book, contact list, and/or distribution list, and generate one or more recommendations including the addressee identification information of the selected addressees.

In some demonstrative embodiments, the recommendation may be provided by server 202 to any suitable device and/or unit used by addressee 204. For example, addressee 204 may receive the recommendation using a computing device, a computer, a PC, a mobile computer, a portable computer, a laptop computer, a notebook computer, a tablet computer, a handheld computer, a handheld device, a PDA device, a handheld PDA device, an on-board device, an off-board device, a hybrid device, a vehicular device, a non-vehicular device, a mobile or portable device, a non-mobile or non-portable device, a wireless communication station, a wireless communication device, a cellular telephone, a wireless telephone, a PCS device, a PDA device which incorporates a wireless communication device, a wired or wireless handheld device (e.g., BlackBerry, Palm Treo), a WAP device, or the like.

In some demonstrative embodiments, the recommendation request message may include item identification information identifying the item, message generator information identifying message generator 292, and addressee identification information identifying addressee 204, e.g., as described above with reference to FIG. 1.

In some demonstrative embodiments, recommendation-based reward manager 228 may be capable of generating the recommendation to be sent to addressee 204 based on the recommendation request message.

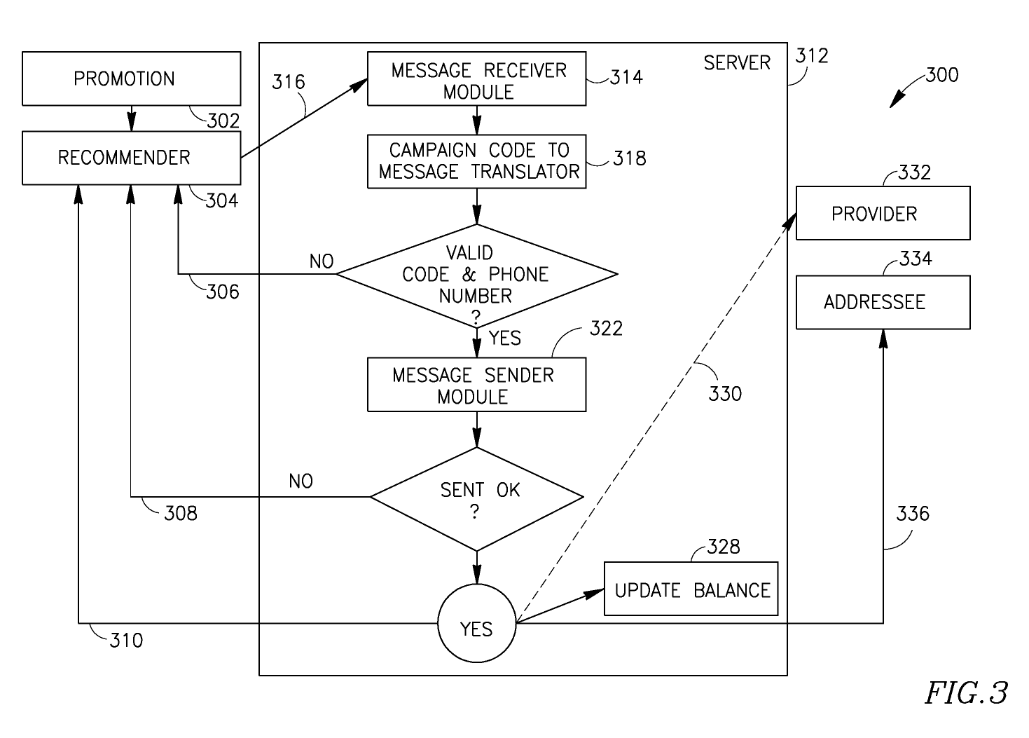

In some demonstrative embodiments, recommendation-based reward manager 228 may be capable of determining the item details corresponding to the item recommended by recommender 210, and/or the recommender details of recommender 204. In one example, recommendation-based reward manager 228 may determine the item details related to the recommended item by comparing the item identification information of the recommendation request with the information of DB 232, e.g., as described below with relation to FIGS. 3 and/or 4. In one example, recommendation-based reward manager 228 may determine the recommender details of recommender 210 based, for example, on the message generator information and/or the details of the reward account corresponding to recommender 210.

In some demonstrative embodiments, recommendation-based reward manager 228 may be capable of sending the recommendation to addressee 204. The recommendation may have any suitable type and/or format. For example, recommendation-based reward manager 228 may send to addressee 204 a recommendation message, e.g., in the form of an E-mail message, a SMS, a MMS, an IM, an ICQ message, an AIM message, a WLM message, a QQ message, a Skype message, an XMPP message, a MIM message, an EIM message, an IVR message, and the like, e.g., as described above with reference to FIG. 1. For example, recommendation-based reward manager 228 may send the recommendation in the form of an SMS to a cellular phone associated with addressee 204. In some demonstrative embodiments, the recommendation may optionally include any other suitable additional information, for example, location-based information corresponding to a location of addressee 204, e.g., as described above with reference to FIG. 1.

In some demonstrative embodiments, recommendation-based reward manager 228 may be capable of sending an acknowledgment to recommender 210 to acknowledge the sending of the recommendation to addressee 204, e.g., as described below with reference to FIGS. 3 and/or 4.

In some demonstrative embodiments, recommendation-based reward manager 228 may receive transaction information indicating that addressee 204 has performed a transaction with relation to the item. For example, recommendation-based reward manager 228 may receive the transaction information offline and/or online, e.g., via communication media 208.

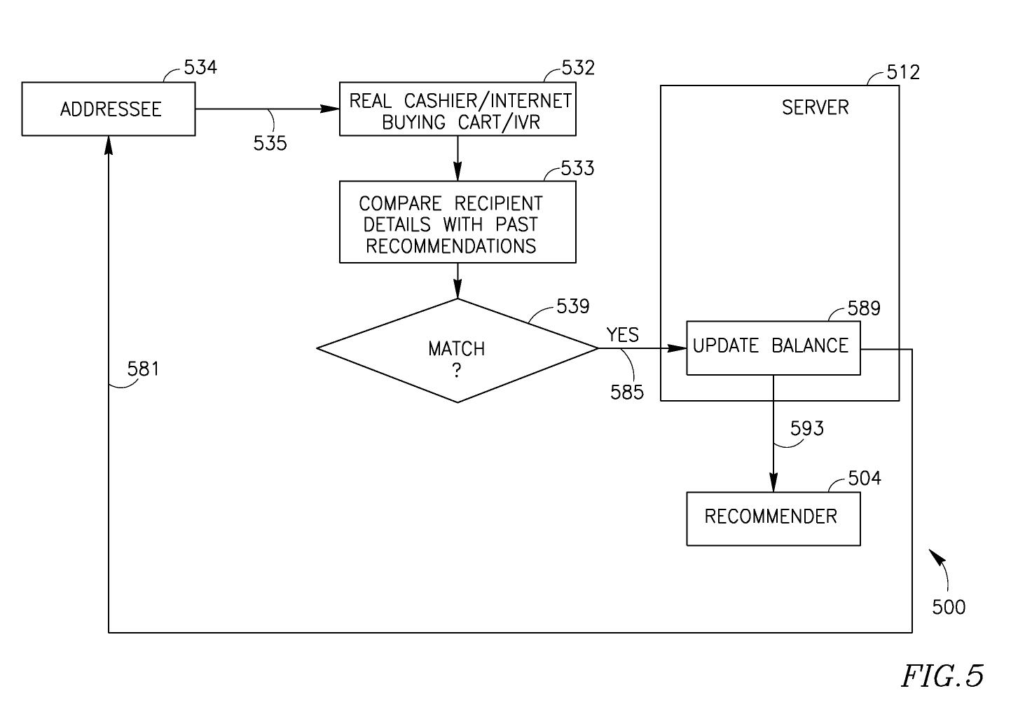

In some demonstrative embodiments, recommendation-based reward manager 228 may receive the transaction information from provider 206, e.g., as described below with reference to FIGS. 5, 6, and/or 8

In some demonstrative embodiments, recommendation-based reward manager 228 may receive the transaction information from addressee 204, e.g., as described below with reference to FIG. 7.

In some demonstrative embodiments, recommendation-based reward manager 228 may receive the transaction information individually indicating that addressee 204 has performed the transaction with relation to the item based on the recommendation from recommender 210, e.g., as described below with reference to FIGS. 5, 7, and/or 8.

In some demonstrative embodiments, recommendation-based reward manager 228 may receive the transaction information relating to a plurality of transactions, for example, as part of a report, a list, and/or file including information relating to a plurality of transactions, e.g., as described above. According to these embodiments, recommendation-based reward manager 228 may be capable of detecting whether addressee 204 has performed the transaction based on the recommendation from recommender 210, e.g., as described below with reference to FIG. 6.

In some demonstrative embodiments, recommendation-based reward manager 228 may receive the transaction information including coupon information sufficient to identify a coupon provided to addressee 204, e.g., as described below with reference to FIGS. 7 and/or 8.

In some demonstrative embodiments, recommendation-based reward manager 228 may be capable of updating a reward account of recommender 210 based on the transaction information. For example, recommendation-based reward manager 228 may update the entry of reward DB 230 corresponding to recommender 210, e.g., as described below with reference to FIGS. 5, 6, 7 and/or 8.

In some demonstrative embodiments, recommendation-based reward manager 228 may be capable of sending to recommender 210 updated account information related to the updated reward account, e.g., as described below with reference to FIGS. 5, 6, 7 and/or 8.

In some demonstrative embodiments, recommendation-based reward manager 228 may be capable of updating an addressee reward account of addressee 204 based on the transaction information. For example, recommendation-based reward manager 228 may update the entry of reward DB 230 corresponding to addressee 204, e.g., as described below with reference to FIGS. 5, 6, 7 and/or 8.

In some demonstrative embodiments, recommendation-based reward manager 228 may be capable of sending to addressee 204 a message including information related to the updated reward account, e.g., as described below with reference to FIGS. 5, 6, 7 and/or 8.

In some demonstrative embodiments, addressee 204 may recommend to another user the item recommended to addressee 204 by recommender 210, e.g., with or without addressee 204 performing the transaction with relation to the item. For example, addressee may send a recommendation request to server 200 to recommend the item to the other user, e.g., similar to the recommendation request sent by recommender 210. In some demonstrative embodiments, recommendation-based reward manager 228 may be capable of rewarding both recommender 210 and addressee 204 for a transaction performed by the other user with relation to the recommended item. For example, recommendation-based reward manager 228 may reward both recommender 210 and addressee 204 based on the recommendation requests from recommender 210 and addressee 204, and/or the transaction information, such that both recommender 210 addressee are, equally or differently, rewarded for the transaction performed by the other user. In some demonstrative embodiments, recommendation-based reward manager 228 may be capable of rewarding any suitable thread and/or multi-level-marketing (MLM) scheme of one or more transactions performed by recommender 210, addressee 204, and/or one or more other users based on a thread of one or more recommendations.

In some demonstrative embodiments, provider 206 and/or server 202 may define one or more requirements to be met before addressee 204 and/or recommender 210 are rewarded with relation to one or more items. For example, provider 206 and/or server 202 may require that recommender 210 may be rewarded only if at least a predefined number of recommendations have been sent; a length of a thread of recommendations, a size of a MLM scheme; and/or a predefined number, e.g., three, of addressees 204 have performed and/or agreed to perform transactions, e.g., within a predefined time period, with relation to the item based on the recommendation.

In some demonstrative embodiments, server 200 may provide to item provider 206 information regarding the transactions and/or rewards performed with relation to items provided by provider 206. For example, server 200 may provide to item provider 206 a periodical report including any statistical information relating to the number of recommendations of an item, the number of transactions performed based on the recommendations, details of the recommenders, and the like.

In some demonstrative embodiments, server 202 may manage a recommendation site 291, e.g., in the form of an Internet web site and/or a cellular site, which may be accessed via communication medium 208.

In some demonstrative embodiments, server 202 may allow addressee 204 and/or recommender 210 to open a mini-site within recommendation site 291. For example, addressee 204 may open a mini-site, in which addressee may post the item identification details of the transacted item, and/or any other details or information, e.g., a picture of the item, a personal recommendation, and the like, in order to recommend the item to other potential users.

In some demonstrative embodiments, recommendation site 291 may include any suitable information relating to recommended items, recommenders, and/or, transactions performed using system 200. In one example, recommendation site 291 may include any statistical information regarding the most recommended items during a predefined time period, e.g., a day, week, month, and/or year; statistical information regarding the users, which have sent the highest number of recommendations during a predefined time period, e.g., a day, week, month, and/or year; and the like.

In some demonstrative embodiments, recommendation site 291 may include a user interface to enable addressee 204 to enter a “consumer-response” regarding the recommended item.

FIG. 3 is a schematic illustration of a recommendation scheme 300 in accordance with one demonstrative embodiments. Although embodiments of the invention are not limited in this respect, in some demonstrative embodiments recommendation scheme 300 may be implemented by one or more elements of a system, e.g., system 200 (FIG. 2) to handle recommendation-based rewarding.

In some demonstrative embodiments, a recommender 304, e.g., recommender 210 (FIG. 2), may learn about an item from any suitable promotion and/or advertisement 302 of the item, e.g., as described above with reference to FIG. 1.

In some demonstrative embodiments, recommender 304 may send a recommendation request message 316 identifying at least one addressee 334, e.g., addressee 204 (FIG. 2) to a recommendation-based rewarding server 312, e.g., recommendation-based rewarding server 202 (FIG. 2). Recommendation request 316 may include item identification information identifying the item, message generator information identifying a message generator used by recommender 304, e.g., the cellular phone number of recommender 304, and addressee identification information identifying addressee 334, e.g., as described above.

In some demonstrative embodiments, recommendation-based rewarding server 312 may include a message receiver 314 capable of receiving recommendation request 316. For example, message receiver 314 may be implemented as part of communication unit 212 (FIG. 2) to receive recommendation request 316 over communication medium 208 (FIG. 2), e.g., as described above. For example, recommendation request 316 may include an SMS message, MMS message, E-mail message and the like, e.g., as described above.

In some demonstrative embodiments, recommendation-based rewarding server 312 may include a translator 318 capable of translating the item identification information into item details sufficient to identify the item to addressee 334. For example, translator 318 may translate the item identification information into the item details based on an item database, e.g., database 232 (FIG. 2). In one example, translator 318 may be implemented as part of manager 228 (FIG. 2), e.g., as described above.

In some demonstrative embodiments, recommendation-based rewarding server 312 may be capable of determining whether the item identification information and/or addressee identification information are valid. Recommendation-based rewarding server 312 may determine that the item identification information is not valid, if for example, the item identification information does not correspond to the item identification information of item database 232 (FIG. 2). For example, if the addressee identification information includes a phone number of addressee 334, then recommendation-based rewarding server 312 may determine whether the phone number of addressee 334 is a valid phone number, e.g., based on any suitable phone directory or phone format. Recommendation-based rewarding server 312 may be capable of sending an error message 306 to recommender 304, e.g., if the item identification information and/or addressee identification information are not valid.

In some demonstrative embodiments, recommendation-based rewarding server 312 may include a message transmitter 322 capable of transmitting a recommendation message 336 to addressee 334 based on recommendation request message 316. Recommendation message 336 may include item details sufficient to identify the item to addressee 334, and recommender details, which are based on the message generator information and are sufficient to identify recommender 304 to addressee 334, e.g., as described above. For example, message transmitter 322 may be implemented as part of communication unit 212 (FIG. 2) to transmit recommendation message 336 over communication medium 208 (FIG. 2), e.g., as described above. In some demonstrative embodiments, recommendation message 336 may optionally include any other suitable additional information, for example, location-based information, e.g., as described above.

In some demonstrative embodiments, recommendation-based rewarding server 312 may be capable of sending an error message 308 to recommender 304, e.g., if recommendation message 336 has not been transmitted successfully and/or has not reached recommender 304

In some demonstrative embodiments, recommendation-based rewarding server 312 may be capable of sending an acknowledgement message 310 to recommender 304, e.g., if recommendation message 336 has been transmitted successfully and/or has been received by recommender 304, as described above.

In some demonstrative embodiments, recommendation-based rewarding server 312 may be capable of updating a reward account 328 of recommender 304 to reflect that recommendation 336 was provided to addressee 334 based on recommendation request 316. For example, manager 228 (FIG. 2) may update reward database 232 (FIG. 2), e.g., as described above.

In some demonstrative embodiments, recommendation-based rewarding server 312 may be capable providing recommendation details 330 corresponding to recommendation 336 to a provider 332 of the item. Recommendation details 330 may include, for example, the addressee identification information and the item identification information. Recommendation details 330 may be provided to provider 332 in any suitable manner, for example, online, e.g., in real-time; and/or offline, e.g., as part of an update file, list or report.

FIG. 4 is a schematic illustration of a recommendation scheme 400 in accordance with another demonstrative embodiment. Although embodiments of the invention are not limited in this respect, in some demonstrative embodiments recommendation scheme 400 may be implemented by one or more elements of a system, e.g., system 200 (FIG. 2) to handle recommendation-based rewarding.

In some demonstrative embodiments, a recommender 404 may learn about an item from any suitable promotion and/or advertisement 402 of the item, e.g., as described above.

In some demonstrative embodiments, recommendation scheme 400 may be implemented to allow recommender 404 to recommend the item to at least one addressee 434 by addressing a recommendation request message 416 directly to addressee 434, e.g., such that recommender 404 may not be required to send a recommendation request to recommendation-based rewarding server as described above with reference to FIG. 3.

In some demonstrative embodiments, recommender 404 may send recommendation request message 416 addressed directly to addressee 434 via a communication medium, e.g., communication medium 208 (FIG. 2). Recommendation request 416 may include item identification information identifying the item, message generator information, e.g., the cellular phone number of recommender 404, and addressee identification information identifying addressee 434, e.g., as described above. In one example, recommendation request 416 may include an SMS message sent by recommender 404 to addressee 434, e.g., as described above.

In some demonstrative embodiments, scheme 400 may include a message receiver 414 capable of receiving messages sent over the communication medium. For example, message receiver 414 may be an SMS message receiver capable of receiving, handling, and/or forwarding SMS messages sent over the communication medium. Message receiver 414 may include any suitable message receiver implemented as part of a network manager and/or network provider of the communication medium, e.g., as part of a mobile communication server of a mobile communication provider server.

In some demonstrative recommendation scheme 400 may include a format detector 415 capable of detecting whether a message 417 received by message receiver 414 includes recommendation request message 416, which may be handled by a recommendation-based rewarding server 412; or any other, e.g., conventional, message 419, which may be forwarded, e.g., directly, to addressee 434. Format detector 415 may be implemented as part of the network manager and/or network provider of the communication medium, e.g., as part of the mobile communication server of the mobile communication provider server.

In some demonstrative embodiments, recommendation-based rewarding server 412 may include a translator 418 capable of translating the item identification information into item details sufficient to identify the item to addressee 434. For example, translator 418 may translate the item identification information into the item details based on an item database, e.g., database 232 (FIG. 2). In one example, translator 418 may be implemented as part of manager 228 (FIG. 2), e.g., as described above.

In some demonstrative embodiments, recommendation-based rewarding server 412 may be capable of determining whether the item identification information and/or addressee identification information are valid. Recommendation-based rewarding server 412 may determine that the item identification information is not valid, if for example, the item identification information does not correspond to the item identification information of item database 232 (FIG. 2). For example, if recommendation request message 416 includes an SMS message addressed to a phone number of addressee 434, then recommendation-based rewarding server 412 may determine whether the phone number of addressee 434 is a valid phone number, e.g., based on any suitable phone directory. Recommendation-based rewarding server 412 may be capable of sending an error message 406 to recommender 404, e.g., if the item identification information and/or addressee identification information are not valid.

In some demonstrative embodiments, recommendation-based rewarding server 412 may include a message transmitter 422 capable of transmitting a recommendation message 436 to addressee 434 based on recommendation request 416. Recommendation message 436 may include item details sufficient to identify the item to addressee 434, and recommender details, which are based on the message generator information and are sufficient to identify recommender 404 to addressee 434, e.g., as described above. For example, message transmitter 422 may be implemented as part of communication unit 212 (FIG. 2) to transmit recommendation message 436 over communication medium 208 (FIG. 2), e.g., as described above. In some demonstrative embodiments, recommendation message 436 may optionally include any other suitable additional information, for example, location-based information, e.g., as described above.

In some demonstrative embodiments, recommendation-based rewarding server 412 may be capable of sending an error message 408 to recommender 404, e.g., if recommendation message 436 has not been transmitted successfully and/or has not reached recommender 404.

In some demonstrative embodiments, recommendation-based rewarding server 412 may be capable of sending an acknowledgement message 410 to recommender 404, e.g., if recommendation message 436 has been transmitted successfully and/or has been received by recommender 404, as described above.

In some demonstrative embodiments, recommendation-based rewarding server 412 may be capable of updating a reward account 428 of recommender 404 to reflect that recommendation 436 was provided to addressee 434 based on recommendation request 416. For example, manager 228 (FIG. 2) may update reward database 232 (FIG. 2), e.g., as described above.

In some demonstrative embodiments, recommendation-based rewarding server 412 may be capable providing recommendation details 430 corresponding to recommendation 436 to a provider 432 of the item. Recommendation details 430 may include, for example, the addressee identification information and the item identification information. Recommendation details 430 may be provided to provider 432 in any suitable manner, for example, online, e.g., in real-time; and/or offline, e.g., as part of an update file, list or report.

In some demonstrative embodiments, one or more elements of recommendation-based rewarding server 412 may be implemented, e.g., together with message receiver 414 and/or format detector 415, as part of the network manager and/or network provider of the communication medium.

FIG. 5 is a schematic illustration of a rewarding scheme 500 in accordance with one demonstrative embodiment. Although embodiments of the invention are not limited in this respect, in some demonstrative embodiments rewarding scheme 500 may be implemented by one or more elements of a system, e.g., system 200 (FIG. 2) to handle recommendation-based rewarding.

In some demonstrative embodiments, scheme 500 may be implemented to provide from a provider 532 of an item (“the transacted item”) to a recommendation-based rewarding server 512 transaction information 585 indicating that an addressee 534 has performed a transaction with relation to the item based on a recommendation from a recommender 504, e.g., as described above.

In some demonstrative embodiments, addressee 534 may include addressee 334 (FIG. 3) and/or 434 (FIG. 4); and/or provider 532 may include provider 332 (FIG. 3) and/or 432 (FIG. 4). Provider 532 may receive from addressee 534, e.g., in connection with the transaction, information 535 identifying addressee 534. Information 535 may include, for example, the phone number of addressee 534, a buyers club identification (ID) of addressee 534, credit card information of addressee 534, and the like. For example, information 535 may be provided to a cashier in a store, an Internet buying cart, an IVR, and the like.

As indicated at block 533, in some demonstrative embodiments provider 532 may detect, based on information 535, whether or not the transaction performed by addressee 534 is related to a recommendation request from a recommender 504, e.g., recommender 304 (FIG. 3) and/or 404 (FIG. 4). For example, provider 532 may compare the details of addressee 534 and/or the transacted item, with recommendation information 330 (FIG. 3) and/or 430 (FIG. 4), which may be stored by provider 532. The detection may be performed on-line, e.g., at real-time; and/or offline, e.g., after addressee has 534 performed the transaction. As indicated at block 539, in some demonstrative embodiments provider 532 may provide transaction information 585 to recommendation-based rewarding server 512, e.g., if it is determined that the transaction performed by addressee 534 is based on a recommendation request from recommender 504.

In some demonstrative embodiments, recommendation-based rewarding server 512 may be capable of updating a reward account 589 of recommender 504 and/or addressee 534 based on transaction information 585, e.g., as described above.

In some demonstrative embodiments, recommendation-based rewarding server 512 may be capable of sending to recommender 504 updated account information 593 related to the updated reward account, e.g., as described above.

In some demonstrative embodiments, recommendation-based rewarding server 512 may be capable of providing addressee 534 with a message 581 including a thank-you message, an introduction message to the services recommendation-based rewarding server 512, an offer to addressee 534 to forward a recommendation of the item, and/or updated account information related to the updated reward account of addressee 534, e.g., as described above.

FIG. 6 is a schematic illustration of a rewarding scheme 600 in accordance with another demonstrative embodiment. Although embodiments of the invention are not limited in this respect, in some demonstrative embodiments rewarding scheme 600 may be implemented by one or more elements of a system, e.g., system 200 (FIG. 2) to handle recommendation-based rewarding.

In some demonstrative embodiments, scheme 600 may be implemented to allow a provider 632 of an item (“the transacted item”) to provide a recommendation-based rewarding server 612 with transaction information 631 relating to a plurality of transactions, e.g., without requiring provider 632 to maintain information related to recommendation requests, e.g., information 330 (FIG. 3) and/or 430 (FIG. 4), and/or to determine whether one or more of the plurality of transactions were performed based on one or more recommendation requests.

In some demonstrative embodiments, addressee 634 may include addressee 334 (FIG. 3) and/or 434 (FIG. 4); and/or provider 632 may include provider 332 (FIG. 3) and/or 432 (FIG. 4). Provider 632 may receive from addressee 634, e.g., in connection with a transaction, information 635 identifying addressee 634. Information 635 may include, for example, the phone number of addressee 634, a buyers club ID of addressee 634, credit card information of addressee 634, and the like. For example, information 635 may be provided to a cashier in a store, an Internet buying cart, an IVR, and the like.

In some demonstrative embodiments, provider 632 may transfer information 631 to recommendation-based rewarding server 612 in any suitable manner, e.g., online and/or offline; as an electronic “soft-copy”, and/or as a physically “hard-copy”, which may be translated into electronic format, for example, using any suitable Optical Character Recognition (OCR) application. Information 631 may include, for example, a report, a list, and/or file including information relating to the plurality of transactions.

As indicated at block 633, in some demonstrative embodiments recommendation-based rewarding server 612 may detect, based on information 631, whether addressee 634 has performed the transaction based on a recommendation request from a recommender 604, e.g., recommender 304 (FIG. 3) and/or 404 (FIG. 4). For example, recommendation-based rewarding server 612 may compare the details of addressee 634 and/or the transacted item, with recommendation information 330 (FIG. 3) and/or 430 (FIG. 4), which may be stored by recommendation-based rewarding server 612. As indicated at block 639, in some demonstrative embodiments recommendation-based rewarding server 612 may send a mismatch message 687 to provider 632, e.g., if information 631 does not indicate that addressee 634 has performed the transaction based on the recommendation request.

In some demonstrative embodiments, recommendation-based rewarding server 612 may be capable of updating a reward account 689 of recommender 604 and/or addressee 634 based on detected transaction information 685 of information 631 indicating that addressee 634 has performed a transaction with relation to the item based on a recommendation from recommender 604.

In some demonstrative embodiments, recommendation-based rewarding server 612 may be capable of sending to recommender 604 updated account information 693 related to the updated reward account, e.g., as described above.

In some demonstrative embodiments, recommendation-based rewarding server 612 may be capable of providing addressee 634 with a message 681 including a thank-you message, an introduction message to the services recommendation-based rewarding server 612, an offer to addressee 634 to forward a recommendation of the item, and/or updated account information related to the updated reward account of addressee 634, e.g., as described above. Recommendation-based rewarding server 612 may be capable of providing provider 632 with an acknowledgement message 687 indicating that recommendation-based rewarding server 612 has detected the transaction performed by addressee 634 based on the recommendation from recommender 604.

FIG. 7 is a schematic illustration of a rewarding scheme 700 in accordance with another demonstrative embodiment. Although embodiments of the invention are not limited in this respect, in some demonstrative embodiments rewarding scheme 700 may be implemented by one or more elements of a system, e.g., system 200 (FIG. 2) to handle recommendation-based rewarding.

In some demonstrative embodiments, rewarding scheme may be implemented to reward a recommender 704 of an item (“the transacted item”) and/or an addressee 734 of the recommendation based on coupon information sufficient to identify a coupon provided to addressee 734, as described in detail below.

In some demonstrative embodiments, addressee 734 may include addressee 334 (FIG. 3) and/or 434 (FIG. 4); recommender 704 may include recommender 304 (FIG. 3) and/or 404 (FIG. 4); and/or a provider 732 of the item may include provider 332 (FIG. 3) and/or provider 432 (FIG. 4).

In some demonstrative embodiments, provider 732 may include a coupon generator 747 to provide addressee 743 with a coupon 761, e.g., upon addressee 734 performing a transaction 735 with relation to the transacted item. For example, coupon generator 747 may generate coupon 761 based on information 733 including the addressee identification information of addressee 734 and the item identification information of the transacted item. For example, provider 732 may receive from addressee 734, e.g., in connection with the transaction, information 735 identifying addressee 734. Information 735 may include, for example, the phone number of addressee 734, a buyers club ID of addressee 734, credit card information of addressee 734, and the like. For example, information 735 may be provided to a cashier in a store, an Internet buying cart, an IVR, and the like. Coupon 761 may include, for example, one or more instructions explaining to addressee 734 how to use coupon 761. Coupon generator 761 may provide coupon 761 to addressee 734 via any suitable medium, for example, electronic media, e.g., using a Radio Frequency Identification (RFID) system, a Bluetooth (BT) system, Infrared Data Association (IRAD), an SMS message, an internet message, and the like; or printed media, e.g., a printed coupon slip. Coupon generator 761 may provide coupon 761 to addressee 734 directly or indirectly, e.g., as part of information provided by a buyers-club account, a bank account, a credit card account, and the like. Coupon 761 may be of any suitable type or format, e.g., a string of characters; a graphic image, e.g., a barcode or any other image; an analog signal, e.g., a sequence of tones, or sounds, a light wave, an IR signal; a digital signal, e.g., a BT signal, and the like.

In some demonstrative embodiments, addressee 734 may provide to a recommendation-based rewarding server 712 coupon information 785, which may be sufficient to identify coupon 761 to recommendation-based rewarding server 712. For example, coupon information 785 may include the item identification information of the transacted item and the addressee identification information of addressee 734.

In some demonstrative embodiments, recommendation-based rewarding server 712 may include a message receiver 714 to receive coupon information 785 from addressee 734 using any suitable communication method, for example, using communication medium 208 (FIG. 2), using a dedicated hardware and/or software based coupon reader, and or using a conventional rebating method, e.g., addressee 734 may send coupon information 785 to a rebate manager, which may transfer coupon information 785 to recommendation-based rewarding server 712.

In some demonstrative embodiments, recommendation-based rewarding server 712 may be capable of updating a reward account 789 of addressee 734 based on coupon information 785, e.g., to reflect the transaction performed by addressee 734.

As indicated at block 721, in some demonstrative embodiments, recommendation-based rewarding server 712 may detect, based on coupon information 785, whether addressee 734 has performed the transaction based on a recommendation request from recommender 704. For example, recommendation-based rewarding server 712 may compare the details of addressee 734 and/or the transacted item, with recommendation information 330 (FIG. 3) and/or 430 (FIG. 4), which may be stored by recommendation-based rewarding server 712.

In some demonstrative embodiments, recommendation-based rewarding server 712 may be capable of updating a reward account 723 of recommender 704, e.g., if addressee 734 has performed the transaction based on a recommendation from recommender 704. In some demonstrative embodiments, recommendation-based rewarding server 712 may be capable of sending to recommender 704 updated account information 793 related to the updated reward account, e.g., as described above.

In some demonstrative embodiments, recommendation-based rewarding server 712 may be capable of providing addressee 734 with a message 781 including a thank-you message, an introduction message to the services recommendation-based rewarding server 712, an offer to addressee 734 to forward a recommendation of the item, and/or updated account information related to the updated reward account of addressee 734, e.g., as described above.

FIG. 8 is a schematic illustration of a rewarding scheme 800 in accordance with yet another demonstrative embodiment. Although embodiments of the invention are not limited in this respect, in some demonstrative embodiments rewarding scheme 800 may be implemented by one or more elements of a system, e.g., system 200 (FIG. 2) to handle recommendation-based rewarding.

In some demonstrative embodiments, rewarding scheme may be implemented to reward a recommender 804 of an item (“the transacted item”) and/or an addressee 834 of the recommendation based on coupon information sufficient to identify a coupon provided to addressee 834, as described in detail below.

In some demonstrative embodiments, addressee 834 may include addressee 334 (FIG. 3) and/or 434 (FIG. 4); recommender 804 may include recommender 304 (FIG. 3) and/or 404 (FIG. 4); and/or a provider 832 of the item may include provider 332 (FIG. 3) and/or provider 432 (FIG. 4).

In some demonstrative embodiments, a recommendation-based rewarding server 812 may provide addressee 843 with a coupon 861, e.g., together with a recommendation provided to addressee 834. In one example, recommendation-based rewarding server 812 may include a coupon generator 847 to generate coupon 861, e.g., based on addressee identification information 811 of addressee 834. Coupon generator 847 may optionally provide coupon information 871 of coupon 861 to provider 832.

In some demonstrative embodiments, provider 832 may receive from addressee 834, e.g., in connection with the transaction of the item, information 835 identifying addressee 834. Information 835 may include, for example, the phone number of addressee 834, a buyers club ID of addressee 834, credit card information of addressee 834, and the like. For example, information 835 may be provided to a cashier in a store, an Internet buying cart, an IVR, and the like.

In some demonstrative embodiments, provider 832 may provide to recommendation-based rewarding server 812 coupon information 885, e.g., upon addressee 834 performing the transaction. Coupon information 885 may be sufficient to identify coupon 861 to recommendation-based rewarding server 812.

In some demonstrative embodiments, recommendation-based rewarding server 812 may be capable of updating a reward account 889 of addressee 834 and/or recommender 804 based on coupon information 885, e.g., to reflect the transaction performed by addressee 834.

In some demonstrative embodiments, recommendation-based rewarding server 812 may be capable of sending to recommender 804 updated account information 893 related to the updated reward account, e.g., as described above.

In some demonstrative embodiments, recommendation-based rewarding server 812 may be capable of providing addressee 834 with a message 881 including a thank-you message, an introduction message to the services recommendation-based rewarding server 812, an offer to addressee 834 to forward a recommendation of the item, and/or updated account information related to the updated reward account of addressee 834, e.g., as described above.

Some embodiments, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid-state memory, magnetic tape, a removable computer diskette, a RAM, a ROM, a rigid magnetic disk, and an optical disk. Some demonstrative examples of optical disks include CD-ROM, CD-R/W, and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method of recommendation-based transaction rewarding, the method comprising:
receiving from a cellular phone associated with a recommender of an item a request message to recommend said item to at least one addressee, wherein said request message includes item identification information identifying said item, a number of said cellular phone, and addressee identification information identifying said addressee;
based on said recommendation request message, sending a recommendation to said addressee, wherein said recommendation includes item details sufficient to identify said item to said addressee, and recommender details sufficient to identify said recommender to said addressee, wherein said recommender details are based on the number of said cellular phone;
receiving transaction information indicating that said addressee has performed a transaction with relation to said item; and
updating a reward account of said recommender based on said transaction information.

2. The method of claim 1, wherein said addressee identification information includes a cellular phone number associated with said addressee, and wherein sending said recommendation comprises sending a message to the cellular phone number of said addressee.

3. The method of claim 1 comprising sending updated account information related to the updated reward account to said recommender.

4. The method of claim 1 comprising:
updating an addressee reward account of said addressee based on said transaction information; and
sending to said addressee a message including information related the updated reward account of said addressee.

5. The method of claim 1, wherein receiving said transaction information comprises receiving coupon information sufficient to identify a coupon provided to said addressee.

6. The method of claim 5, wherein said coupon comprises a coupon provided to said addressee upon performing said transaction, and wherein receiving said coupon information comprises receiving said coupon information from said addressee.

7. The method of claim 5 comprising:
providing said coupon to said addressee; and
receiving said coupon information if said addressee performs said transaction.

8. The method of claim 1, wherein said item details include at least one of a name of said item, a description of said item, a location corresponding to said item, details of a provider of said item, and a price of said item; and wherein said recommender details include at least one of a name of said recommender, a nickname of said recommender, an electronic-mail address of said recommender, an instant-messaging identity of said recommender, and a phone number of said recommender.

9. The method of claim 1, wherein said item identification information comprises an offer code sufficient to identity a predefined offer of said item.

10. The method of claim 1, wherein said request message comprises a short-message-service message.

11. The method of claim 1, wherein said addressee is said recommender.

12. A method of recommendation-based transaction rewarding, the method comprising:
receiving a recommendation request message to recommend an item to at least one addressee, wherein said recommendation request message includes item identification information identifying said item, message generator information identifying a generator of said request message, an authentication of said generator information, and addressee identification information identifying said addressee;
based on said recommendation request message, sending a recommendation to said addressee, wherein said recommendation includes item details sufficient to identify said item to said addressee, and recommender details sufficient to identify a recommender of said item to said addressee, wherein said recommender details are based on said message generator information;
receiving transaction information indicating that said addressee has performed a transaction with relation to said item; and
updating a reward account of said recommender based on said transaction information.

13. The method of claim 12, wherein said transaction information indicates said addressee has performed said transaction with relation to said item based on said recommendation.

14. The method of claim 12, wherein said transaction information includes information relating to a plurality of transactions, and wherein said method comprises detecting whether said addressee has performed said transaction based on said recommendation.

15. The method of claim 12 comprising sending to said recommender updated account information related to the updated reward account.

16. The method of claim 12 comprising:
updating an addressee reward account of said addressee based on said transaction information; and
sending to said addressee updated account information related to the updated reward account of said addressee.

17. The method of claim 12, wherein receiving said transaction information comprises receiving coupon information sufficient to identify a coupon provided to said addressee.

18. A recommendation-based transaction rewarding server capable of receiving from a cellular phone associated with a recommender of an item a request message to recommend said item to at least one addressee, wherein said request message includes item identification information identifying said item, a number of said cellular phone, and addressee identification information identifying said addressee; based on said recommendation request message, sending a recommendation to said addressee, wherein said recommendation includes item details sufficient to identify said item to said addressee, and recommender details sufficient to identify said recommender to said addressee, wherein said recommender details are based on the number of said cellular phone; receiving transaction information indicating that said addressee has performed a transaction with relation to said item; and updating a reward account of said recommender based on said transaction information.

19. The recommendation-based transaction rewarding server of claim 18, wherein said addressee identification information includes a cellular phone number associated with said addressee, and wherein sending said recommendation comprises sending a message to the cellular phone number of said addressee.

20. The recommendation-based transaction rewarding server of claim 18, wherein said server is capable of sending to said recommender updated account information related to the updated reward account.

21. The recommendation-based transaction rewarding server of claim 18, wherein said server is capable of updating an addressee reward account of said addressee based on said transaction information; and sending to said addressee a message including information related the updated reward account of said addressee.

22. The recommendation-based transaction rewarding server of claim 18, wherein said transaction information comprises coupon information sufficient to identify a coupon provided to said addressee.

23. The recommendation-based transaction rewarding server of claim 18, wherein said request message comprises a short-message-service message.
